(19) United States
(12) Patent Application Publication
(10) Pub. No.: US 2018/0319242 A1
(43) Pub. Date: Nov. 8, 2018

(54) LOCKABLE TILTING ASSEMBLY FOR MOTOR VEHICLE

(71) Applicant: Hersh Goel, Summit, NJ (US)

(72) Inventor: Hersh Goel, Summit, NJ (US)

(21) Appl. No.: 15/947,847

(22) Filed: Apr. 8, 2018

Related U.S. Application Data
(60) Provisional application No. 62/502,125, filed on May 5, 2017.

(51) Int. Cl. B60G 21/00; B62D 61/06; B62D 9/02; B62D 9/04; F16H 1/16

(52) U.S. Cl. CPC B60G 21/007; B62D 61/065; F16H 2019/046; B62D 9/04; F16H 1/16; B62D 9/02

(57) ABSTRACT

The present invention discloses a three-wheeled motor vehicle having a lockable tilting mechanism. The tilting mechanism is configured to tilt the vehicle at any angle without the need for a driver to put their feet on the ground outside the vehicle. The tilting mechanism is further configured to lock the tilting of the vehicle at any desired angle by the driver. The present invention enables the driver to alter the lean from within the vehicle if the lean is locked in an undesirable position. The tilting mechanism is further configured to enable the driver to lock or unlock the lean of the vehicle in a manner that allows the driver to intuitively switch between steering and counter-steering.

### BACKGROUND OF THE INVENTION

### A. Technical Field

The present invention generally relates to motor vehicles, and more specifically relates to a three-wheeled vehicle having a lockable tilting mechanism.

### B. Description of Related Art

In general, several vehicles (such as motorcycles) are designed to lean from one side to another for turning the vehicles at high speeds. These vehicles may also have more than two wheels. For vehicles with three or more wheels that lean (for example the Piaggio MP3 scooter), a conformational change is effected to allow leaning while the vehicle is still keeping all its wheels on the ground. The act of leaning or tilting effectively moves the centre of mass of a vehicle laterally i.e., perpendicular to the direction of travel as well as the vertical axis. In a ‘freely leaning’ vehicle, this lateral displacement of the centre of mass is accomplished by letting the vehicle fall a little bit to the side under the influence of gravity. Thus, such tilting is accompanied by lowering the centre of mass of the vehicle as well. At low speeds these vehicles are in an unstable equilibrium and the driver needs to usually place their feet on the road to keep such vehicle upright and prevent toppling.

Previous attempts have been made to make closed canopy tilting vehicles where the driver does not need to place there feet on the ground—such as the well known ‘Monotracer’. At low speeds, this vehicle extended out mechanical arms to the ground to stabilise the upright position of the vehicles. This relieved the rider from having to put their feet on the ground (allowing an enclosed cabin design for the rider/driver). However, these mechanical arms only lock in a position of full extension and cannot stabilize a vehicle that is already in a lean. Any attempt to deploy the mechanical arm while the vehicle is already leaning into a turn will likely result in an adverse outcome. This prevented widespread adoption of this vehicle.

Further, a vehicle with any number of wheels stabilized by any mechanical means into a fixed tilt position (locked tilt) need be steered like a car. Thus, the front wheel of the vehicle is steered in the direction that the driver needs to turn. On the contrary, a freely leaning vehicle that is amenable to toppling due to gravity (unlocked tilt) needs to be ‘counter steered’. ‘Counter steered’ means that the front wheel is initially pointed away from the intended direction of the turn and top portion of the vehicle then leans or ‘topples’ into the intended direction of the turn. At this stage, the front wheel is turned towards the intended direction of the turn and the turn is executed. Therefore, as the vehicle's lean functionality is locked and unlocked, the driver must alternate between steering and counter steering respectively.

In vehicles (such as the Monotracer) where the vehicle automatically unlocks it's ability to tilt when a certain speed is achieved, many drivers have toppled their vehicles. This is because the driver fails to ‘counter steer’ the vehicle after the vehicle automatically unlocks the tilt functionality. Instead, the driver continues to steer in the manner that they were doing prior to the automatic unlocking of lean. This identifies another problem with current state of art of vehicles having a lockable tilt mechanism—the inability of the driver to intuitively switch between steering and countersteering.

Hence, there is a need for a mechanism that allows a three-wheeled vehicle to lock the lean of the vehicle in any configuration of lean and allow the driver to correct the lean of the vehicle from inside the vehicle. Further, the mechanism needs to lock and unlock the lean of the vehicle in a manner that allows the driver to intuitively switch between steering and counter-steering. This would allow manufacture of closed canopy freely tilting vehicles with a mass appeal.

### SUMMARY OF THE INVENTION

The present invention discloses a three-wheeled motor vehicle having a lockable tilting mechanism. The tilting mechanism is configured to all the vehicle to freely tilt at any angle according to the driving conditions. The tilting mechanism is further configured to lock the tilting of the vehicle at any desired angle by the driver. The tilting mechanism is further configured to correct the lean or tilt angle from inside the vehicle without the need for driver to put their feet on the ground outside the vehicle. The tilting mechanism is further configured to enable the driver to lock or unlock the lean of the vehicle in a manner that allows the driver to intuitively switch between steering and counter-steering.

In brief, this is achieved by having a first gear whose rotation is invariably coupled to the tilting of the vehicle; A second gear is enmeshed with a worm gear; A mechanism that can reversibly couple (or link) the rotation of the first and second gear; The mechanism being operable by the foot of the driver; The worm gear being able to be rotated by the driver.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows a side view of a three-wheeled vehicle having a tilting mechanism in an embodiment of the present invention.

FIG. 2A shows a cross sectional view of a three-wheeled vehicle including a foot pedal assembly (114) and tilt correction wheel assembly (116) in accordance with various embodiments.

FIG. 2B shows the foot pedal assembly (114) in depressed position due to a restraining force F1, according to an embodiment.

FIG. 3 shows a front view of tilting of three-wheeled vehicle, according to an embodiment.

FIG. 4A shows a front wheel assembly of a three-wheeled vehicle, according to an embodiment of the present invention.

FIG. 4B shows leftward tilting of front wheel assembly, according to an embodiment of the present invention.

FIG. 4C shows rightward tilting of front wheel assembly, according to an embodiment of the present invention.

FIG. 5A shows a front view of the first gear, in an embodiment of the present invention.

FIG. 5B shows side view of the first gear, in an embodiment of the present invention.

FIG. 6 shows a tilting mechanism when the foot pedal assembly (114) is in depressed position due to restraining force (F1), in an embodiment of the present invention.

FIG. 7 shows the tilting mechanism when the pedal assembly (114) is released from depressed position, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

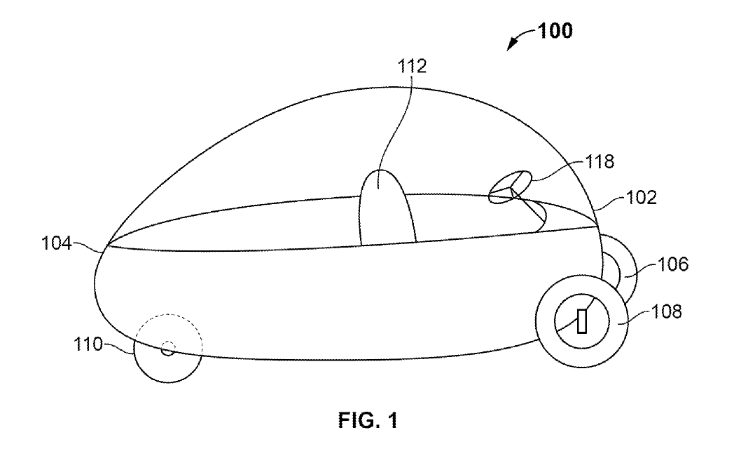

Referring to FIG. 1 illustrates a three-wheeled tilting vehicle 100 having a lockable tilting mechanism. The three-wheeled tilting vehicle 100 comprises a front section 102 and a rear section 104. The front section 102 of the vehicle 100 comprises a lockable tilting mechanism. The tilting mechanism or assembly of the vehicle 100 comprises two front wheels 106 and 108. The rear section 104 of the vehicle 100 comprises a rear wheel 110.

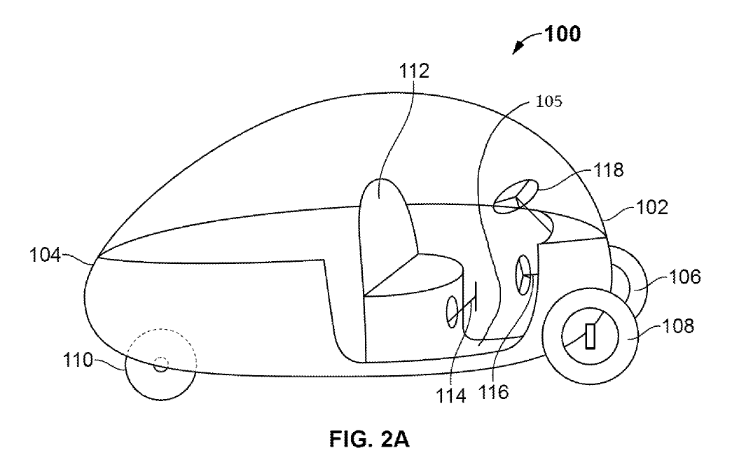

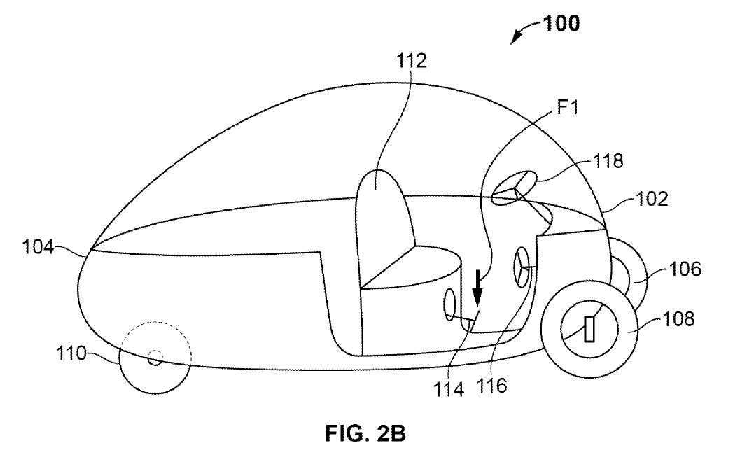

Referring to FIG. 2A, in an embodiment, the lockable tilting mechanism also includes a foot pedal assembly 114, and a tilt correction wheel assembly 116. Further, the front section 102 includes a driver's seat 112 and a vehicle steering wheel assembly 118. The foot pedal assembly 114 is positioned below the driver's seat 112. The foot pedal assembly 114 is configured to depressed (by applying downward pressure) or released from the depressed position by the driver. In an embodiment, when the foot pedal assembly 114 is in non-depressed position as shown in FIG. 2A, the vehicle 100 would not lean or tilt due to gravity or reasonable external forces. The driver of the vehicle may place there feet on the floor 105 of the vehicle.

In another embodiment, when the foot pedal assembly 114 is in depressed position as shown in FIG. 2B due to a restraining force F1, the vehicle 100 is configured to lean in either right or left direction under the influence of gravity or reasonable external forces. The vehicle 100 together with the lockable tilting mechanism is configured to tilt laterally when the vehicle 100 is performing a turn.

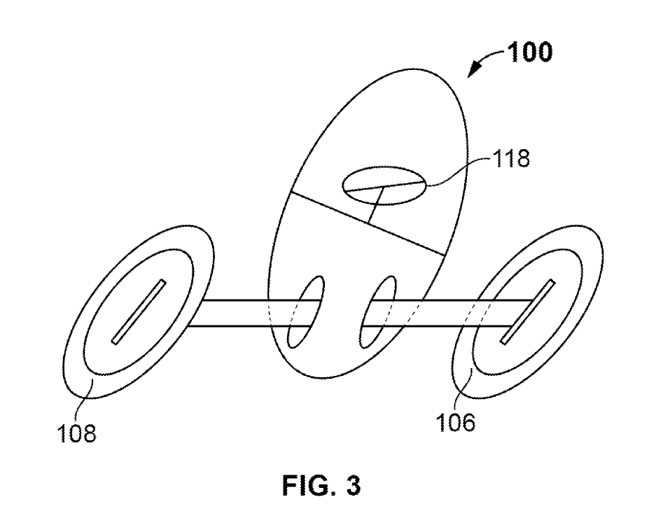

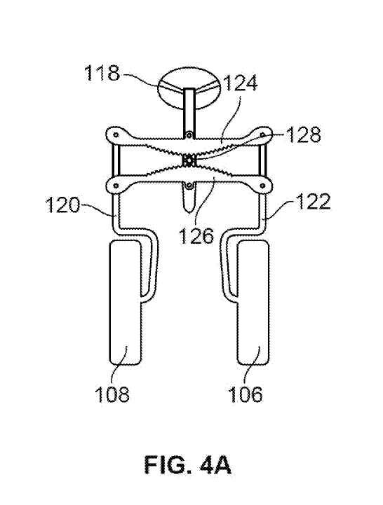

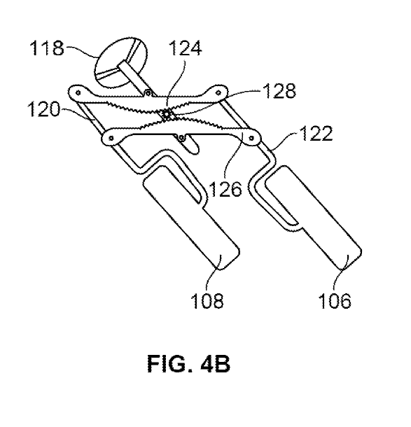

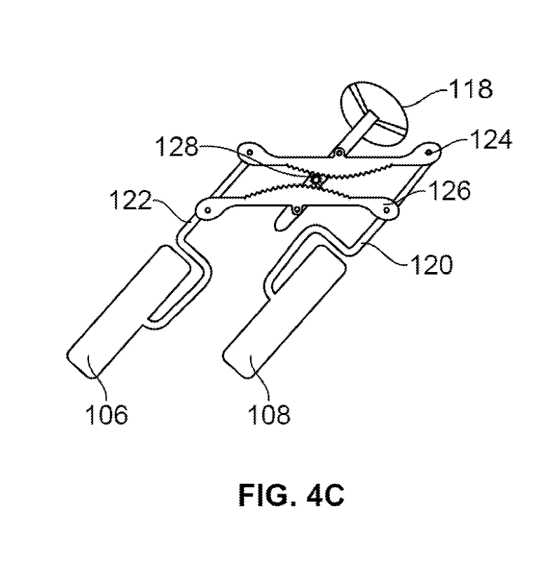

Referring to FIG. 3 shows a front view of tilting of three-wheeled vehicle 100, according to an embodiment. Referring to FIG. 4A, the front wheel assembly comprises two front wheels 106, 108, each mounted on a side bar 120, 122. The tilting assembly further includes a pair of cross bar 124, 126, which is pivotally connected to the side bar 120, 122 of the front wheels 106, 108. In an embodiment, the pair of cross bar 124, 126 has a curved surface facing towards each other. The tilting assembly further includes a gear assembly comprising a first gear 128 enmeshes the curved surface of each cross bar 124, 126. Referring FIG. 4B and FIG. 4C, the front wheels 106, 108 mounted on the side bars 120, 122 to allow the wheels 106, 108 to tilt relative to a vertical axis while remaining parallel to each other. This is because the side bars 124, 126 are connected to each other by the pair of curved cross bar 124, 126. The cross bar is coupled to the steering wheel 118 of the vehicle 100, thereby allowing the vehicle 100 and the wheels 106, 108, 110 to tilt in unison. As depicted in FIG. 4A—FIG. 4C, the tilting of the vehicle 100 about a vertical axis rotates the first gear 128. The first gear 128 invariably and predictably rotates with the tilting of said vehicle. Further, rotation of first gear 128 will cause the tilt assembly, and therefore vehicle 100, to change its tilt configuration. However, the axis of the first gear 128 maintains a fixed position relative to the steering wheel 118 and body of the vehicle 100.

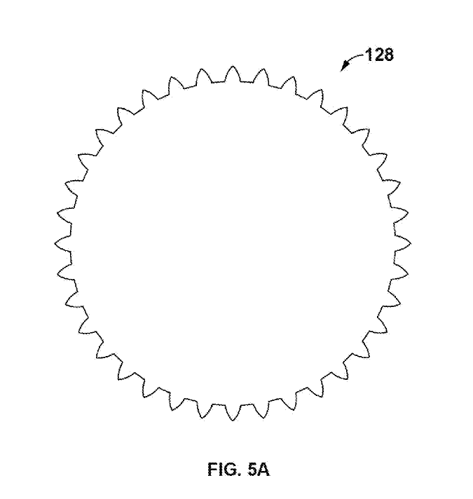

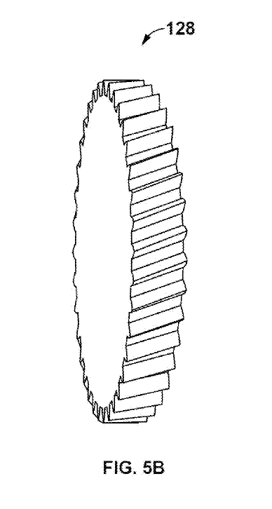

FIG. 5A illustrates a front view of the first gear 128 in an embodiment of the present invention. FIG. 5B illustrates a side view of the first gear 128 displaying a grooved circumference which meshes with the lower and the upper cross bars 124, 126 in an embodiment of the present invention.

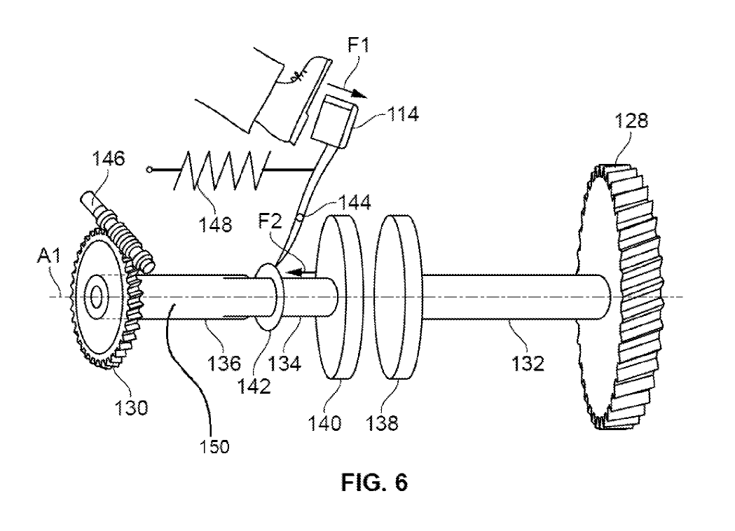

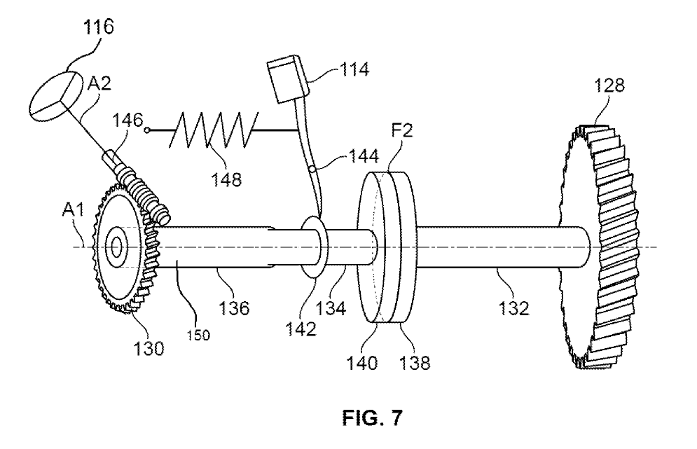

The first gear 128 invariably and predictably rotates with the tilting of said vehicle. In one embodiment, the tilting mechanism comprises a reversible mechanism to couple the rotation of the first gear 128 to the second gear 130 (shown in FIG. 6). An embodiment of the reversible mechanism to couple the rotation of the first gear 128 to the second gear 130 is described in FIG. 6 and FIG. 7.

Referring to FIG. 6, the reversible mechanism comprises a shaft assembly and friction plates to couple the rotation of the first gear 128 to the second gear 130, in an embodiment of the present invention. The shaft assembly comprises a first shaft 132, second shaft 134 and a third shaft 136. The first shaft 132 having one end affixed to the first gear 128 and another end affixed to a first friction surface 138. The second shaft 134 having one end affixed to a second friction surface 140 and a third shaft 136 having one end affixed to a second gear 130 and another end of the third shaft 136 is configured to allow another end of the second shaft 134 to telescope in and out. While shafts 134 and 136 can telescope in and out of each other, They may not rotate independant of each other. Rotational torque applied to shaft 134 is transmitted to shaft 136 without slippage and vice versa. In an embodiment, the second 134 and third shaft 136 contain a high pressure gas 150 in between them. The high-pressure gas causes the second friction plate 140 to move towards the first friction plate 138. The second shaft 134 is firmly connected to the lip 142. The Lip 142 is coupled with the foot pedal assembly 114. Further gear assemblies 128 and 130, shaft assemblies 132 and 136, first friction plate 138 and second friction plate 140 comprises a common axis A1.

Still referring to FIG. 6 when a force F1 is applied by depressing the foot pedal assembly 114 by the driver, a force F2 i.e., a restraining force is applied to the second shaft 134. The restraining force is transmitted across a fulcrum 144 by lever coupled to the foot pedal assembly 114. The restraining force prevent displacement of the second shaft 134 due to the high-pressure gas 150. The second shaft 134 is prevented from displacement as the lip 142 is being held back by the foot pedal assembly 114. Therefore, the first frictional plate 138 and the second frictional plate 149 are not in contact. This allows the first gear 128 to rotate without restriction between the upper and lower cross bar 124, 126 that were depicted in FIGS. 4A, 4B and 4C. This enables tilting of the vehicle 100 under the effect of the gravity and reasonable external forces.

Referring to FIG. 7 shows the tilting mechanism when the foot pedal assembly 114 is released from depressed position, according to an embodiment of the present invention. When the foot pedal assembly 114 is released form the depressed position, there is no restraining force acting on second shaft 134. Then the high-pressure gas 150 within the second shaft 134 and the third shaft 136 pushes the second friction plate 140 to the right such that it apposes the first friction plate 138. This, in turn moves the second shaft 134 and the lip 142 mounted to the second shaft 134. The foot pedal assembly 114 has accordingly turned counter clockwise due to the torque exerted on it by the lip 142 as well as the spring assembly 148. While both the frictional surfaces 138 and 140 are in contact with each other, they only rotate together and torque on one friction surface gets transmitted to the other.

Still referring to FIG. 7, the first and second frictional surface 138, 140 are now in contact with each other and cannot turn or slide relative to each other. Therefore, first gear 128 cannot rotate without synchronous turning of the first shaft 132, first frictional surface 138, second frictional surface 140, second shaft 134, third Shaft 136 and second gear 130. Further second gear 130 is enmeshed with a worm gear 146. The worm gear 146 would effectively resist any torque applied to the second gear 130. Thus, the second gear 130 cannot turn due to any torque applied to it via the third shaft 136. This entails that the tilt configuration of the vehicle 100 is effectively locked in place and will not change due to external forces such as gravity on vehicle 100.

FIG. 7 further illustrates an operation to alter the tilt of the vehicle 100 during the state of ‘locked tilt’. The worm gear 146 is coupled to tilt correction wheel assembly 116, which is configured to be turned by the driver. The turning of the tilt correction wheel assembly 116, causes rotation of the worm gear 146. The axis of rotation of the worm gear 146, tilt correction wheel assembly 116 is represented as A2. As explained above, the worm gear 146 would not turn in spite of any torque exerted on second gear 130. However due to the nature of worm gears (that is well known to experts in the field), the worm gear 146 is configured to turn when rotated by the driver of the vehicle 100 by manipulating tilt correction wheel assembly 116. This would entail the turning of second gear 130, third shaft 136, second shaft 134, second frictional plate 140, first frictional plate 138, first shaft 132 and first gear 128 as a unit. As first gear 128 turns, it will alter the tilt of the vehicle 100 as seen in FIGS. 4A, 4B and 4C. This allows the driver to achieve any tilt of the vehicle 100 that the driver desires and resist reasonable external forces attempting to alter the tilt. As shown in FIG. 2B, the foot pedal assembly 114 is configured to be depressed by the driver by at least one of their feet, keeping the foot off the floor 105 of the vehicle 100. As depicted in FIG. 2A, if the driver were to place both there feet on the floor 105 of the vehicle, the foot pedal assembly 114 is automatically released upwards.

The advantages of the present invention include: tilts the vehicle 100 at any angle according to the driving conditions without the need for driver to put their feet on the ground outside the vehicle 100; locks the tilt of the vehicle 100 at any desired angle; corrects the lean or tilt angle from inside the vehicle 100; and enables the driver to unlock or lock the lean of the vehicle 100 in a manner that simulates the natural tendency of a driver of a motorcycle to place feet on the ground to break a fall of the motorcycle. This allows the driver to intuitively switch between steering and counter-steering.

Another benefit of the proposed invention is that the components inside the driver compartment (depicted in FIG. 2A) including the tilt correction wheel assembly 116 would not be moved due to external forces or tilt of the vehicle 100. As an example, consider the vehicle 100 as depicted in FIG. 4C, having tilted under the effects of gravity to its left and the operator of the vehicle has relieved any depression of foot pedal 114. Then the operator of the vehicle 100 starts operating the tilt correction wheel assembly 116 in an anti-clockwise manner, to make the vehicle 100 upright. Here the driver is working against gravity. In case of slipping of operator hand from the tilt correction wheel 116, it would be dangerous for the operator if the tilt correction wheel assembly 116 starts spinning in clockwise direction as the vehicle 100 tilt or falls back to its left under the effects of gravity. However, according to the present invention, incorporation of a worm gear 146 between the tilt correction wheel assembly 116 and the tilting mechanism of the vehicle 100, prevents this scenario—improving safety.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation.

Accordingly, the present invention is not limited to the specific embodiments illustrated herein.

What is claimed is:

1. A titling assembly in association with the vehicle body, comprising:
a gear assembly comprising,
a first gear, wherein the first gear invariably and predictably rotates with the tilting of said vehicle and
a second gear enmeshed with a worm gear;
a mechanism is configured to reversibly couple the rotation of the first gear with the second gear; and
a pedal assembly configured to be operated by a driver who applies a restraining force on the pedal assembly;
wherein the rotation of the first gear and the second gear is delinked by the mechanism on applying the restraining force to the pedal assembly, thereby allows tilting of vehicle due to external forces, and
wherein the rotation of the first gear is coupled to the second gear by the mechanism on releasing the restraining force, thereby preventing alteration of tilt of the vehicle due to external forces.

2. The assembly according to claim 1, wherein the first gear is enmeshed between first and second apposing crossbars, wherein the said crossbars are pivotally interconnected to a pair of side bars, wherein the sidebars each mount a wheel.

3. The assembly according to claim 1, further comprises a tilt correction wheel assembly, to rotate the worm gear. The worm gear in turn rotates second and first gear assembly as a unit to alter the vehicle tilt angle when there is no restraining force on the pedal assembly.

4. The assembly according to claim 1, wherein the reversible mechanism comprises planetary gears to couple the rotation of the first gear with the second gear.

5. The assembly according to claim 2, wherein the cross bar is coupled to a main body of the vehicle.

6. The assembly according to claim 1, wherein the pedal assembly is configured to be operated by the driver's foot such that the driver lifts at least one foot off the floor of the vehicle to apply restraining force on the pedal assembly.

7. The assembly according to claim 1, is incorporated in three-wheel vehicles.
